(19) United States
(12) Patent Application Publication
(10) Pub. No.: US 2025/0132454 A1
(43) Pub. Date: Apr. 24, 2025

(54) ENDCAP FOR A PRISMATIC BATTERY CELL

(71) Applicant: GM Global Technology Operations LLC, Detroit, MI (US)

(72) Inventors: Ryan Patrick Hickey, Austin, TX (US); Phillip Daniel Hamelin, Clarkston, MI (US); Uma Shanker Reddy Andhuri, Shelby Township, MI (US); Alexander M. Bilinski, Avoca, MI (US); Amanda Keech, Waterford, MI (US)

(21) Appl. No.: 18/490,166

(22) Filed: Oct. 19, 2023

(51) Int. Cl. H01M 50/358; H01M 50/209; H01M 50/291

(52) U.S. Cl. CPC H01M 50/358; H01M 50/209; H01M 50/291; H01M 2220/20

(57) ABSTRACT

A battery assembly includes a battery pan and battery cells. The battery cells are supported within the battery pan and disposed in a plurality of rows. The battery assembly includes a plurality of vents, and each of the plurality of vents is defined by a floor of the battery pan, support members, and a battery tray. Each vent extends a length of each row. An endcap is coupled to the structural plates of the battery pan. The endcap includes a plurality of apertures, a baffle, and a vent channel. The baffle has a baffle wall disposed opposite the plurality of apertures. The baffle wall extends to the ceiling and the floor of the elongated body. The vent channel extends along the baffle and is configured to carry vent gas. The battery assembly also includes a pack vent configured to exhaust the vent gas from the endcap.

### INTRODUCTION

The present disclosure relates to a battery cell and more particularly to a battery cell assembly that has thermal management.

A rechargeable energy storage system (RESS), for example a prismatic battery assembly, typically includes a plurality of electrode stacks, or battery cells. Each of the electrode stacks includes an anode and a cathode spaced apart by an electrically insulative separator material. The electrode stacks are placed next to one another, typically in a case or enclosure to protect the electrode stacks from the ambient environment. The case also functions to contain an electrolyte fluid within the case and around the electrode stacks. An electrode stack in a RESS may undergo an uncontrolled thermal event known as thermal runaway propagation (TRP). During a TRP event, electrode stacks may vent gas, which becomes heated as it travels toward the case or pack vent. The increase in temperature of the heated gas caused by a TRP event may lead to an increase in the temperature of the gas, which vents and is mixed with ambient air outside the RESS.

While prior art methods and systems for minimizing temperature of gas venting from a RESS during a TRP event exist and may achieve their particular purpose, a need still exists for a new and improved system for thermally managing vent gas. Accordingly, batteries that have cooling capability for heated vent gas are needed.

### SUMMARY

According to several aspects of the present disclosure, a battery assembly having an endcap for thermal management is provided. The battery assembly includes a battery tray, a battery pan and a plurality of battery cells. The battery tray has a tray top surface. The battery pan is supported by the battery tray. The battery pan has at least one side wall and a floor. A plurality of structural plates is coupled to the floor, and the battery pan has a plurality of support members for supporting the floor. The plurality of battery cells is supported within the battery pan. Each of the plurality of battery cells has a cell vent port, and the plurality of battery cells is disposed in a plurality of rows defined by the plurality of structural plates. The battery assembly includes a plurality of vents, and each of the plurality of vents is defined by the floor of the battery pan, one of the plurality of support members, another of the plurality of support members, and the tray top surface. Each vent extends a length of each row of the plurality of rows, and each cell vent port of the plurality of battery cells is in fluid communication with each vent of the plurality of vents. The battery assembly includes an endcap having an elongated body. The elongated body has a length, a ceiling, and a floor. The endcap includes a plurality of apertures, a baffle, and a vent channel. The plurality of apertures is disposed along the length of the elongated body. The baffle has a baffle wall extending the length of the elongated body. The baffle wall extends to the ceiling and the floor of the elongated body and is coupled to a first end of the elongated body. The vent channel is defined by the baffle and the elongated body and extends along the baffle and is configured to carry vent gas. The battery assembly also includes a pack vent disposed proximate the first end of the elongated body and configured to exhaust the vent gas from the endcap.

In accordance with another aspect of the disclosure, the endcap is coupled to the plurality of structural plates of the battery pan.

In accordance with another aspect of the disclosure, the baffle wall is disposed opposite the plurality of apertures.

In accordance with another aspect of the disclosure, the battery assembly includes a baffle that is configured in a linear configuration.

In accordance with another aspect of the disclosure, the battery assembly includes a baffle formed from a steel stamping.

In accordance with another aspect of the disclosure, the battery assembly further includes an external channel coupled to an external side of one side wall of the battery pan. The external channel has a channel entrance and a channel vent. The channel entrance is disposed proximate to and receives vent gas from the pack vent. The channel vent exhausts the vent gas.

In accordance with another aspect of the disclosure, the battery assembly includes an external channel configured in a non-direct pattern.

In accordance with another aspect of the disclosure, the battery assembly includes an external channel configured in a wave pattern.

According to several aspects of the present disclosure, a battery assembly having an external channel for thermal management is provided. The battery assembly includes a battery tray, a battery pan and a plurality of battery cells. The battery tray has a tray top surface. The battery pan is supported by the battery tray. The battery pan has at least one side wall and a floor. A plurality of structural plates is coupled to the floor, and the battery pan has a plurality of support members for supporting the floor. The plurality of battery cells is supported within the battery pan. Each of the plurality of battery cells has a cell vent port, and the plurality of battery cells is disposed in a plurality of rows defined by the plurality of structural plates. The battery assembly includes a plurality of vents, and each of the plurality of vents is defined by the floor of the battery pan, one of the plurality of support members, another of the plurality of support members, and the tray top surface. Each vent extends a length of each row of the plurality of rows, and each cell vent port of the plurality of battery cells is in fluid communication with each vent of the plurality of vents. The battery assembly includes an external channel coupled to an external side of one side wall of the battery pan. The external channel has a channel entrance and a channel vent. The channel entrance is disposed proximate to and receives vent gas from the pack vent. The channel vent exhausts the vent gas.

In accordance with another aspect of the disclosure, the battery assembly includes a plurality of vents extending along the battery in a fore-aft configuration.

In accordance with another aspect of the disclosure, the battery assembly further includes an endcap having an elongated body. The elongated body has a length, a ceiling, and a floor, and the endcap is coupled to the plurality of structural plates of the battery pan. The endcap includes a plurality of apertures, a baffle, and a vent channel. The plurality of apertures is disposed along the length of the elongated body. The baffle has a baffle wall extending the length of the elongated body, and the baffle wall is disposed opposite the plurality of apertures. The baffle wall extends to the ceiling and the floor of the elongated body and is coupled to a first end of the elongated body. The vent channel is defined by the baffle and the elongated body and extends along the baffle and is configured to carry vent gas. The battery assembly also includes a pack vent disposed proximate the first end of the elongated body and configured to exhaust the vent gas from the endcap.

In accordance with another aspect of the disclosure, the battery assembly includes an endcap that provides fluid communication of the vent gas from the plurality of vents to the pack vent.

In accordance with another aspect of the disclosure, the battery assembly includes an end cap that is perpendicular to the plurality of rows.

According to several aspects of the present disclosure, a battery assembly having an endcap and an external channel for thermal management is provided. The battery assembly includes a battery tray, a battery pan and a plurality of battery cells. The battery tray has a tray top surface. The battery pan is supported by the battery tray. The battery pan has at least one side wall and a floor. A plurality of structural plates is coupled to the floor, and the battery pan has a plurality of support members for supporting the floor. The plurality of battery cells is supported within the battery pan. Each of the plurality of battery cells has a cell vent port, and the plurality of battery cells is disposed in a plurality of rows defined by the plurality of structural plates. The battery assembly includes a plurality of vents, and each of the plurality of vents is defined by the floor of the battery pan, one of the plurality of support members, another of the plurality of support members, and the tray top surface. Each vent extends a length of each row of the plurality of rows, and each cell vent port of the plurality of battery cells is in fluid communication with each vent of the plurality of vents. The battery assembly includes an endcap having an elongated body. The elongated body has a length, a ceiling, and a floor, and the endcap is coupled to the plurality of structural plates of the battery pan. The endcap includes a plurality of apertures, a baffle, and a vent channel. The plurality of apertures is disposed along the length of the elongated body. The baffle has a baffle wall extending the length of the elongated body, and the baffle wall is disposed opposite the plurality of apertures. The baffle wall extends to the ceiling and the floor of the elongated body and is coupled to a first end of the elongated body. The vent channel is defined by the baffle and the elongated body and extends along the baffle and is configured to carry vent gas. The battery assembly also includes a pack vent disposed proximate the first end of the elongated body and configured to exhaust the vent gas from the endcap. The battery assembly includes an external channel coupled to an external side of one side wall of the battery pan. The external channel has a channel entrance and a channel vent. The channel entrance is disposed proximate to and receives vent gas from the pack vent. The channel vent exhausts the vent gas.

In accordance with another aspect of the disclosure, the battery assembly includes the endcap in fluid communication from the plurality of vents to the pack vent.

In accordance with another aspect of the disclosure, the battery assembly includes an endcap welded to the tray top surface, the plurality of structural plates, and the floor.

In accordance with another aspect of the disclosure, the battery assembly includes a baffle configured in a linear configuration.

In accordance with another aspect of the disclosure, the battery assembly includes a baffle formed from steel stamping.

In accordance with another aspect of the disclosure, the battery assembly includes an external channel configured in a non-direct pattern.

In accordance with another aspect of the disclosure, the battery assembly includes an external channel configured in a wave pattern.

### BRIEF DESCRIPTION OF THE DRAWINGS

The drawings described herein are for illustration purposes only and are not intended to limit the scope of the present disclosure in any way.

FIG. 1 is an environmental view illustrating an example of a vehicle having a battery assembly configured to passively cool and exhaust vent gas in a TRP event, in accordance with the present disclosure.

FIG. 2 is a perspective view illustrating the battery assembly shown in FIG. 1, wherein the battery assembly is mechanically coupled to a battery tray and includes an endcap and an external channel, in accordance with the present disclosure.

FIG. 3 is a partial side cross section view illustrating a battery cell and a vent in the battery assembly shown in FIG. 2, wherein the vent is defined by a bottom wall of a battery pan, a first and second support member, and the battery tray, in accordance with the present disclosure.

FIG. 4A is a partial perspective view illustrating a portion of the battery assembly shown in FIG. 2, wherein an endcap is disposed on a side of the battery, in accordance with the present disclosure.

FIG. 4B is a magnified view of a side cross-section illustrating a portion of the endcap shown in FIG. 4A, in accordance with the present disclosure.

FIG. 5 is a top view illustrating the endcap shown in FIGS. 2 and 4, wherein the endcap includes a baffle, in accordance with the present disclosure.

FIG. 6A is a side elevation view illustrating the external channel shown in FIG. 2, wherein the external channel includes a plate member having a curved protruded wall in an undulated configuration, in accordance with the present disclosure.

FIG. 6B is a magnified view of a cross-section of the external channel shown in FIG. 6A, in accordance with the present disclosure.

### DETAILED DESCRIPTION

The following description is merely exemplary in nature and is not intended to limit the present disclosure, application, or uses.

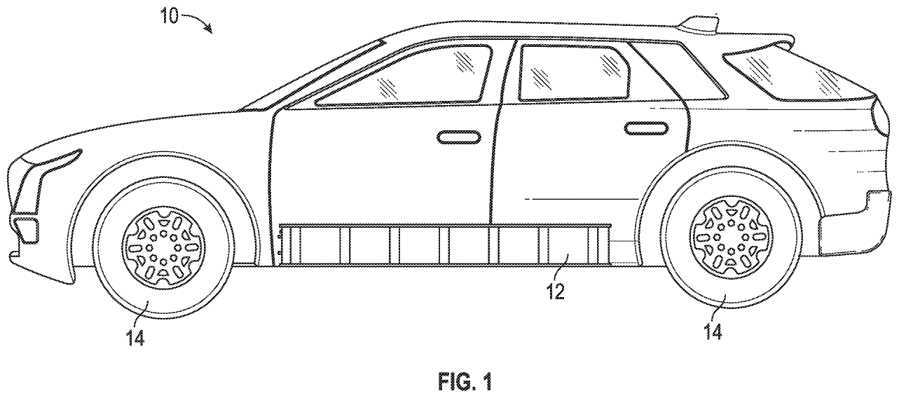

Referring to FIG. 1, a vehicle 10 having a battery assembly 12 configured to cool gas venting from the battery assembly 12 is shown, according to the principles of the present disclosure. The battery assembly 12 is illustrated with an exemplary vehicle 10, and the vehicle 10 is an electric vehicle or hybrid vehicle having wheels 14 driven by electric motors/inverters. The electric motors/inverters receive motive power from the battery assembly 12. While the vehicle 10 is illustrated as a passenger road vehicle, it should be appreciated that the battery assembly 12 may be used with various other types of vehicles. For example, the battery assembly 12 may be used in nautical vehicles, such as boats, or aeronautical vehicles, such as drones or passenger airplanes. Moreover, the battery assembly 12 may be used as a stationary power source separate and independent from a vehicle.

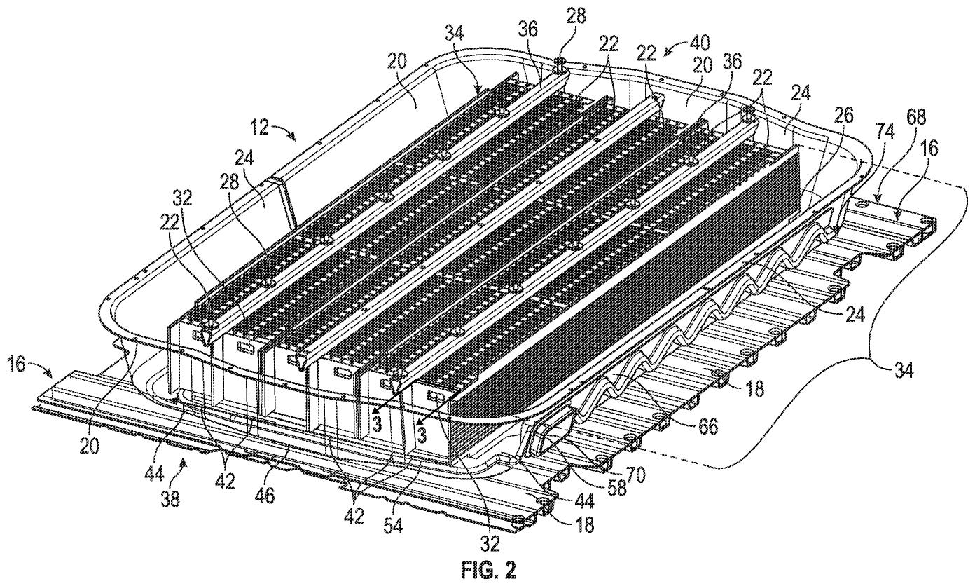

Referring now to FIG. 2, a perspective view of the battery assembly 12 is shown and generally includes a battery tray 16, a battery pan 20 and a plurality of battery cells 22. The battery tray 16 is a generally planar member having a tray top surface 18. Battery tray 16 is supported by and mounted to the vehicle 10 using mechanical fasteners 28 such as bolts (not shown) or the like threaded through apertures in the battery tray 16. The battery tray 16 provides structural support to the battery pan 20.

The battery pan 20 provides structural support and containment for a plurality of battery cells 22 of the battery assembly 12. The battery pan 20 includes a side wall 24 and a floor 26. Side wall 24 extends around a periphery of the floor 26. Moreover, battery pan 20 includes a plurality of support members 30 extending from the floor 26. The plurality of support members 30 are disposed on and coupled (e.g., welded) to the tray top surface 18 of battery tray 16. For example, the plurality of support members 30 can include a plurality of flanges positioned between and coupled to the tray top surface 18 and the floor 26 of the battery pan 20.

With continuing reference to FIG. 2, a plurality of battery cells 22 is supported on floor 26 of battery pan 20. Each of the plurality of battery cells 22 has a cell vent port 32 for releasing vent gas in the event of a TRP event. A plurality of structural plates 36 define a plurality of rows 34 in the battery pan 20. The structural plates 36 are coupled to the floor 26 of the battery pan 20. A portion of the plurality of battery cells 22 are disposed and arranged in one of the plurality of rows 34. In the example shown in FIG. 2, the rows 34 are arranged in a fore-aft configuration wherein the rows extend from a front 38 of the battery assembly 12 and vehicle 10 along a length of the battery pan 20 to a back 40 (distal from the front 38) of the battery pan 20. It should be appreciated that the rows 34 may be arranged in other configurations, for example extending along a width of the battery pan 20 (e.g., perpendicular to a fore-aft direction).

In the example illustrated in FIG. 2, the battery cells 22 are prismatic cells whose chemistry is enclosed in a rigid, rectangular casing. The rectangular casing allows for efficient stacking of the battery cells 22 in the battery pan 20. In other instances, the battery assembly 12 may include cylindrical lithium-ion battery cells and/or pouch cells, for example. It should be appreciated that any type of battery cell 22 may be employed. The structural plates 36 provide structural support and separation between the rows 34.

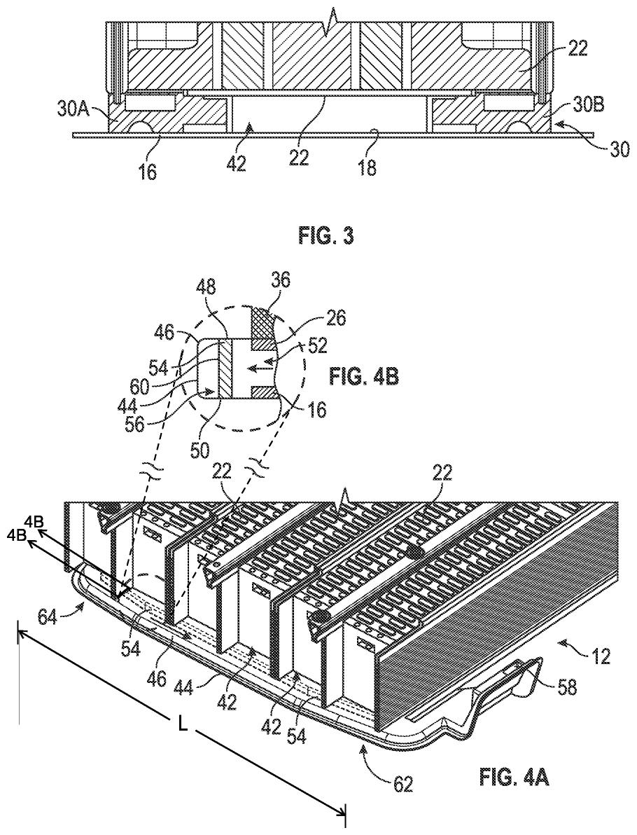

Referring to FIG. 3, a cross sectional view through the battery tray 16, battery pan 20 and a battery cell 22 as indicated in FIG. 2 is illustrated, in accordance with an aspect of the present disclosure. A vent 42 corresponds with each row 34 in the battery pan 20 to vent gas from each of the plurality of battery cells 22 in each row 34 during a TRP event. Each vent 42 is defined by the floor 26 of the battery pan 20, one of the plurality of support members 30 (e.g., a first support member 30A), another of the plurality of support members 30 (e.g., a second support member 30B), and the tray top surface 18 of battery tray 16. In FIG. 3, the first support member 30A and the second support member 30B are shown as flanges disposed between the floor 26 and the tray top surface 18. Each vent 42 extends along a length of each row of the plurality of rows 34. Additionally, each cell vent port 32 of the plurality of battery cells 22 is in fluid communication with each vent 42 of the plurality of vents 42. When a TRP event occurs, resulting gas is released from at least one cell vent port 32 of the plurality of battery cells 22 into one of the plurality of vents 42, and the resulting gas flows through the vent 42 along the row 34 and away from the plurality of battery cells 22.

Referring now to FIGS. 4A and 4B, a partial perspective view of a portion of the battery assembly 12 and a magnified view of a side cross-section of an endcap 44 is illustrated. The endcap 44 is a steel stamping, for example, configured to receive vent gas from the vents 42. The endcap 44 has an elongated body 46. More specifically, the elongated body 46 has a length L, a ceiling 48, and a floor 50. The endcap 44 is mechanically couplable (e.g., welded) to the floor 26 of the battery pan 20, structural plates 36, and the tray top surface 18.

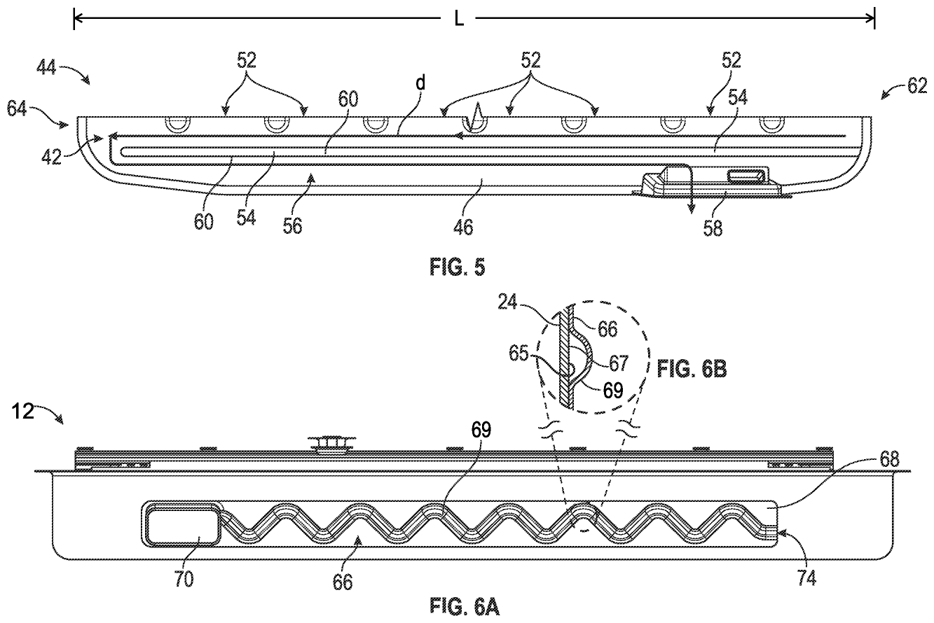

Shown in FIG. 5, the endcap 44 includes a plurality of vent apertures 52, a baffle 54, a vent channel 56, and a pack vent 58. Each of the plurality of vent apertures 52 are disposed along the length L of the elongated body 46 and are in fluid communication with the vents 42 to receive the vent gas from each of the plurality of vents 42.

With continuing reference to FIGS. 4A, 4B and 5, the baffle 54 has a baffle wall 60 extending the length of the elongated body 46. The baffle wall 60 is disposed opposite the plurality of vent apertures 52 and extends to the ceiling 48 and the floor 50 of the elongated body 46. Additionally, the baffle wall 60 is coupled (e.g., welded) to a first end 62 of the elongated body 46. The baffle 54 can be formed of a steel stamping and stamped into and integral with the endcap 44. The vent channel 56 is defined by the baffle 54 and the elongated body 46 and extends the length of the baffle wall 60 on a first side of the baffle wall 60 opposite the vent apertures 52. An opening between the end of the baffle wall 60 and the end of the elongated body 46 defines a vent channel opening to the opposite side of the baffle wall 60. Accordingly, the vent channel 56 extends from the vent channel opening along the baffle wall 60 toward the first end 62 of the elongated body 46. As the vent gas enters the endcap 44 from the vent apertures 52, the vent gas is directed along the vent channel 56, as indicated by arrow d, from the first end 62 toward a second end 64 of the elongated body 46 to the pack vent 58. The presence of the baffle wall 60 causes the vent gas to take a longer path (i.e. along the vent channel 56) instead of directly to the pack vent 58 in the absence of the baffle wall 60. The longer path created by the vent channel 56 provides an opportunity for the vent gas to cool further before reaching pack vent 58. The pack vent 58 is disposed proximate the first end 62 of the elongated body 46 and configured to exhaust vent gas from the endcap 44 through an opening or aperture in wall 24 of the battery pan 20. The vent channel 56 exhausts the vent gas through the pack vent 58.

In alternate aspects of the present disclosure, the battery assembly 12 may not include an endcap 44. In this aspect of the present disclosure, vent gas is directly exhausted from an interior of the battery pan 20 from the vents 42 to the pack vent 58. Cooling of the vent gas occurs as the vent gas contacts the metal surface of the elongated body 46, the baffle wall 60 and other metal surfaces within the endcap 44. This cooling serves to passively cool the vent gas as it travels through the endcap 44.

Referring again to FIG. 2 and now with reference to FIGS. 6A and 6B, FIG. 6A is a side view of the battery assembly 12 and FIG. 6B is a magnified view of a cross-section of an external plate 66 mechanically coupled to the battery assembly 12. As shown in FIG. 6A, in accordance with another aspect of the present disclosure, the external plate 66 is provided on an external surface 67 of wall 24 of the battery pan 20. The external plate 66 has an elongated plate member 68 having a curved protruding wall 69 (as shown in FIG. 6B). An external vent channel 65 is defined by the curved protruding wall 69 and external surface 67 of wall 24. The external vent channel 65 has a channel entrance 70 and a channel exit vent 74. The channel entrance 70 includes an opening or an aperture that is in communication with the pack vent 58. The channel entrance 70 receives vent gas from the pack vent 58. The external vent channel 65 carries vent gas exhausted from the pack vent 58.

Moreover, because the external vent channel 65 is external the battery pan 20, the external vent channel 65 is disposed in a crash basin of the vehicle 10 and is configured to be crushable, thus resulting in better space utilization. The external vent channel 65, as shown in FIG. 2, can be in a fore-aft configuration (e.g., extending parallel to the plurality of rows 34). It will be appreciated that the external vent channel 65 can be oriented in other configurations (e.g., perpendicular to the rows 34).

As depicted in FIGS. 2 and 6A, external vent channel 65 is arranged in a wave or undulated pattern. More specifically, external vent channel 65 extends from the channel entrance 70 in a sinuous shape or an alternating curvature configuration. The external vent channel 65 directs the vent gas to flow in a non-direct path, which increases surface area contacted by the vent gas and increases residence time of the vent gas flowing through the external vent channel 65, thus providing increased cooling of the vent gas. It will be appreciated that the external channel 66 may include other configurations, for example a linear configuration. The vent gas is exhausted from the external vent channel 65 through the channel exit vent 74. Channel exit vent 74 exhausts the vent gas to an ambient environment (e.g., a vehicle environment).

In some implementations the battery assembly 12 includes both an endcap 44 and an external vent channel 65 for carrying and cooling the vent gas. However, in some implementations, the battery assembly 12 may include endcap 44 without the external vent channel 65, or the battery assembly 12 may include only external vent channel 65 without endcap 44.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A battery assembly, comprising:
a battery tray having a tray top surface;
a battery pan supported by the battery tray, wherein the battery pan has at least one side wall and a floor, and wherein a plurality of structural plates is coupled to the floor, and wherein the battery pan has a plurality of support members for supporting the floor;
a plurality of battery cells supported within the battery pan, each of the plurality of battery cells having a cell vent port, wherein the plurality of battery cells is disposed in a plurality of rows defined by the plurality of structural plates;
a plurality of vents, wherein each of the plurality of vents is defined by the floor of the battery pan, one of the plurality of support members, another of the plurality of support members, and the tray top surface, wherein each vent extends a length of each row of the plurality of rows, and wherein each cell vent port of the plurality of battery cells is in fluid communication with each vent of the plurality of vents;
an endcap having an elongated body, wherein the elongated body has a length, a ceiling, and a floor, and wherein the endcap includes:
a plurality of apertures disposed along the length of the elongated body;
a baffle having a baffle wall extending the length of the elongated body, wherein the baffle wall extends to the ceiling and the floor of the elongated body and is coupled to a first end of the elongated body; and
a vent channel defined by the baffle and the elongated body and extending along the baffle, and configured to carry vent gas; and
a pack vent disposed proximate the first end of the elongated body and configured to exhaust the vent gas from the endcap.

2. The battery assembly of claim 1, wherein the endcap is coupled to the plurality of structural plates of the battery pan.

3. The battery assembly of claim 1, wherein the baffle wall is disposed opposite the plurality of apertures.

4. The battery assembly of claim 3, wherein the baffle is configured in a linear configuration.

5. The battery assembly of claim 4, wherein the baffle is formed from a steel stamping.

6. The battery assembly of claim 1, further comprising:
an external vent channel coupled to an external surface of one side wall of the battery pan, wherein the external vent channel has a channel entrance and a channel exit vent, wherein the channel entrance is disposed proximate to and receives vent gas from the pack vent, and wherein the channel exit vent exhausts the vent gas.

7. The battery assembly of claim 6, wherein the external vent channel is configured in a non-direct pattern.

8. The battery assembly of claim 7, wherein the external vent channel is configured in a wave pattern.

9. A battery assembly, comprising:
a battery tray having a tray top surface;
a battery pan supported by the battery tray, wherein the battery pan has at least one side wall and a floor, and wherein a plurality of structural plates is coupled to the floor, and wherein the battery pan has a plurality of support members for supporting the floor;
a plurality of battery cells supported within the battery pan, each of the plurality of battery cells having a cell vent port, wherein the plurality of battery cells is disposed in a plurality of rows defined by the plurality of structural plates;
a plurality of vents, wherein each of the plurality of vents is defined by the floor of the battery pan, one of the plurality of support members, another of the plurality of support members, and the tray top surface, wherein each vent extends a length of each row of the plurality of rows, and wherein each cell vent port of the plurality of battery cells is in fluid communication with each vent of the plurality of vents;
a pack vent disposed in a side wall of the battery pan and configured to exhaust vent gas from the battery pan; and
an external channel coupled to an external surface of one side wall of the battery pan, wherein the external channel has a channel entrance and a channel exit vent, wherein the channel entrance is disposed proximate to and receives vent gas from the pack vent, and wherein the channel exit vent exhausts the vent gas.

10. The battery assembly of claim 9, wherein the plurality of vents extend along the battery assembly in a fore-aft configuration.

11. The battery assembly of claim 9, further comprising:
an endcap having an elongated body, wherein the elongated body has a length, a ceiling, and a floor, wherein the endcap is coupled to the plurality of structural plates of the battery pan, and wherein the endcap includes:
a plurality of apertures disposed along the length of the elongated body;
a baffle having a baffle wall extending the length of the elongated body, wherein the baffle wall is disposed opposite the plurality of apertures, wherein the baffle wall extends to the ceiling and the floor of the elongated body and is coupled to a first end of the elongated body; and
a vent channel defined by the baffle and the elongated body and extending along the baffle, and configured to carry vent gas.

12. The battery assembly of claim 11, wherein the endcap is in fluid communication from the plurality of vents to the pack vent.

13. The battery assembly of claim 11, wherein the endcap is perpendicular to the plurality of rows.

14. A battery assembly, comprising:
a battery tray having a tray top surface;
a battery pan supported by the battery tray, wherein the battery pan has at least one side wall and a floor, and wherein a plurality of structural plates is coupled to the floor, and wherein the battery pan has a plurality of support members for supporting the floor;
a plurality of battery cells supported within the battery pan, each of the plurality of battery cells having a cell vent port, wherein the plurality of battery cells is disposed in a plurality of rows defined by the plurality of structural plates;
a plurality of vents, wherein each of the plurality of vents is defined by the floor of the battery pan, one of the plurality of support members, another of the plurality of support members, and the tray top surface, wherein each vent extends a length of each row of the plurality of rows, and wherein each cell vent port of the plurality of battery cells is in fluid communication with each vent of the plurality of vents;
an endcap having an elongated body, wherein the elongated body has a length, a ceiling, and a floor, wherein the endcap is coupled to the plurality of structural plates of the battery pan, and wherein the endcap includes:
a plurality of apertures disposed along the length of the elongated body;
a baffle having a baffle wall extending the length of the elongated body, wherein the baffle wall is disposed opposite the plurality of apertures, wherein the baffle wall extends to the ceiling and the floor of the elongated body and is coupled to a first end of the elongated body; and
a vent channel defined by the baffle and the elongated body and extending along the baffle, and configured to carry vent gas;
a pack vent disposed proximate the first end of the elongated body and configured to exhaust the vent gas from the endcap; and
an external vent channel coupled to an external surface of one side wall of the battery pan, wherein the external vent channel has a channel entrance and a channel exit vent, wherein the channel entrance is disposed proximate to and receives vent gas from the pack vent, and wherein the channel exit vent exhausts the vent gas.

15. The battery assembly of claim 14, wherein the endcap is in fluid communication from the plurality of vents to the pack vent.

16. The battery assembly of claim 15, wherein the endcap is welded to the tray top surface, the plurality of structural plates, and the floor.

17. The battery assembly of claim 16, wherein the baffle is configured in a linear configuration.

18. The battery assembly of claim 17, wherein the baffle is formed from steel stamping.

19. The battery assembly of claim 14, wherein the external channel is configured in a non-direct pattern.

20. The battery assembly of claim 19, wherein the external channel is configured in a wave pattern.
